(19) United States
(12) Patent Application Publication
(10) Pub. No.: US 2008/0046431 A1
(43) Pub. Date: Feb. 21, 2008

(54) Document processing method

(76) Inventor: John David McGough, Wilmington, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 11/706,450

(22) Filed: Feb. 14, 2007

Related U.S. Application Data
(60) Provisional application No. 60/837,781, filed on Aug. 15, 2006.

(51) Int. Cl. G06F 7/08

(52) U.S. Cl. 707/7

(57) ABSTRACT

Document sets, such as real estate deeds, are recorded at multiple recording stations with each deed set being recorded in the order that the set is presented, thereby preserving the arrival sequence of the documents as required by first-to-file recording systems. Document sets, with each set containing at least one document, are received at each of the recording stations independent of other recording stations. A unique arrival identifier is assigned to set, with the identifier including a time stamp for the document set and a document number for each document in the set. The time stamp differs from the time stamp assigned to the immediately preceding set received at any other receiving station by a predetermined time segment. Book and page numbers may also be assigned to each document, and a barcode label including the unique arrival identifier and the book and page numbers can be attached to each document.

This invention claims the benefit of the filing date of U.S. Provisional Patent Application No. 60/837,781, filed Aug. 15, 2006.

### BACKGROUND OF THE INVENTION

(1) Field of the Invention

The present invention relates to a system for processing incoming documents from multiple sources while preserving the precise arrival order sequence of each document; and in particular to the processing of real estate deeds.

(2) Description of the Prior Art

In certain situations, such as the North Carolina “race to record” requirement mentioned below, incoming real estate documents are required to be processed in a “first come-first served” ordering sequence. This means that all documents in a set received from a “document source”, the term being used herein to describe the origin of the documents to be recorded, e.g., an individual, mailed package, or electronic transmission, must be processed and recorded in a chronological sequence before documents from the next source's set can be processed. This is a requirement for official recording of property and other related documents in States where a “race to record” condition exists. In this situation, for example, if two individuals filed a deed for the same property, the legal owner of the property would be the individual that recorded the deed first, or as otherwise defined by the state's laws.

Originally, the Register of Deeds and other official recording offices addressed this requirement by marking each page in the incoming documents with a book number and page number, as well as recording date, to indicate the sequence in which the pages were received. To compare the order of arrival of any two documents you would see which one had the earlier book and page number. The book and page number corresponds to the actual book and page of the archived document. Other more recent approaches have used an “instrument number” (instead of a book and page number) which is marked on each page based on arrival sequence. The pages are divided later into physical books.

Conventionally, in order to ensure the correct arrival sequence, a single receiving station is used at each office. As each individual or source of documents, or sets of documents, arrives the source is placed in line after the other sources that have arrived before it. All documents from each source are processed in the order of presentation. Once all documents are processed, the next source of documents is processed. This process is repeated until all sources in the line are processed. The challenge with this approach comes when the volume of documents to record increases. In these high-volume cases, the “single queue” is quickly overwhelmed and becomes a bottleneck.

Documents may be processed by “instant service” in which documents are returned immediately, or by “delayed service” in which documents are returned at a later time. These procedures are described in detail below.

Instant Service—In cases where there is low volume and sufficient time, the receiving station processes each document up to the point that it can be returned to the individual (document source) immediately (before the next document source is processed). This usually includes verifying the appropriate fees are paid, marking each document page with a physical book and page number (or instrument number) and possibly additional identifying labels, collecting all needed information about the document and creating a digital image of the document. At that point, all additional document processing, indexing, warranting, etc., performed later can be accomplished with the information and digital images of the documents that have been received initially. This process is often called “Instant Service.” This approach may keep the individuals waiting in line the longest.

Delayed Service—In cases where higher volume and longer processing delays are present, documents may be placed in an “inbox” of sorts. This inbox is processed by the receiving station in “First Come—First Served” order; meaning that the most recent documents are placed at the bottom of the stack and the current document being processed comes off the top of the stack (a first-in-first-out queue). This allows quicker receiving and throughput for the individuals (document sources) waiting in line. However, the individual presenting the document must return at a later time to retrieve the processed document. Also, the utmost care is required by the staff persons to ensure that the documents are kept together and in proper order. With this method, if a document cannot be recorded due to errors in the document, insufficient recording fees, etc., it must be set aside for later processing and requires additional interaction with the presenting individual, etc. The possibility for documents to become lost or otherwise mis-indexed is high with this method. Also, if this method is utilized directly with the “Instant Recording” method, maintaining true document arrival order is difficult or impossible.

Many Register of Deeds offices use a combination of recording methods that fall between the extremes of “Instant Recording” and “Delayed Service”.

A single receiving station or multiple receiving stations may be used. With a single receiving station, individuals (document sources) wait in a single line for each to be processed. For incoming mail and related incoming sources, it is typically decided as part of office policy when during the day the incoming mail is processed. In the single receiving station approach, documents can be processed with both the above mentioned “Instant Service” or “Delayed Service” methods.

Multiple receiving stations may also be set up to receive document sources. Individuals or other document sources choose which receiving station they wish to stand in line for. However, only one receiving station can be enabled or “unlocked” at a time—in a rather “round robin” approach. For quicker throughput “Delayed Service” is used, and the focus is on getting all pages in each document accounted for and the order recorded as quickly as possible.

These documents are then queued (stacked) for later processing and return. Once this is done the station is disabled or “locked” so that it cannot receive another document and one of the other stations can be “unlocked” so the next station in line can process their sources documents. This preserves the requirement that all documents from each respective person (document source) are received in the order in which the people arrived. In cases where “Instant Service” or a combination of “Instant Service” and “Delayed Service” is used, there is little advantage to having multiple receiving stations as far as allowing people in line to be processed more quickly. Additionally, great care is required to ensure that the documents are kept in appropriate order when they are processed.

In summary, the previous approaches would compromise between either having “Instant Service” and slow throughput of people (document sources) waiting in line or “Delayed Service” which increased the required per document work load as well as the chance for errors. If multiple receiving stations were used, they would have to be carefully setup so only one station could function at a time and combination of “Delayed Service” would be needed to allow quicker throughput. With this approach there was still the increased per document workload and chance for errors. The challenge still exists in all cases that if the first person in line has 100 documents and the second person in line only has 1 document, the second person must wait until all 100 of the first person's documents are received and accounted for—causing a significant bottle-neck. This is true for both single and multiple receiving stations.

Thus, there is a need for a method by which document sets, such as sets of real estate deeds, can be simultaneously processed as a plurality of recording stations while preserving the arrival sequence of the documents.

### SUMMARY OF THE INVENTION

The present system allows multiple receiving stations to simultaneously process incoming documents from multiple sources while preserving the “first come-first served” ordering sequence of the arrival time of each source delivering the set of documents.

The following is an example of how the herein mentioned system overcomes the aforementioned bottle-neck issues and truly allows multiple receiving stations to process incoming documents from multiple sources simultaneously while carefully preserving the precise arrival time of the individual documents. The Detailed Description of The Invention is specifically directed to recording of real estate deeds. However, it will be understood that this methodology can be used for the processing of other sets of documents where the “first come-first served” ordering sequence of the arrival time of each source delivering the set of documents is needed.

The present system allows multiple receiving stations to simultaneously receive and process document sets. As used herein, the term “document set” or “real estate deed set” is intended to encompass one or more documents with each document including one or more pages. Thus, a document set can be a single document with one or more pages, or a plurality of documents, each with one or more pages. Further “documents” could be physical or electronic format pages of text, images, or any other type of file, while preserving the arrival sequence of the documents so that they will be chronologically ordered by the arrival of both the sets and the internal order of the documents within the set.

The system automatically creates an Arrival Identifier at the appropriate time through a combination of date and precise time stamp with document arrival sequence number and creation of a corresponding physical book and page number. The system allows the documents to be either completely processed and returned to the individual delivering the set of documents while they wait (frequently referred to as “Instant Service”), or allow partial processing where the documents are returned at a later time (frequently referred to as “Delayed Service”). It is scalable to allow as many receiving stations as needed without compromising the arrival order of each document. The system contains multiple check steps to ensure that all needed requirements are met before the document is processed.

Upon receipt, the number of pages in each document within the set is counted, and a database of record books is searched to determine the last book number. The remaining number of pages in the book is compared with the number of pages of the document. If the number of document pages does not exceed the number of pages available in the current book, the document is given the current book number and the next available page numbers within the current book. If the number of document pages exceeds the number of available pages in the current book, that book is closed and the next book number in sequence is used, along with the first number of pages in that book equal to the document pages.

This information is preserved for access by the next station recording a document. The book/page number of the documents need not be in the sequence of the documents arrival. For example, if a first station receives a set of two documents and a second station then receives a set of a single document, the single document from the second station may be assigned a book/pages number between that of the two documents from the first station. However, the unique arrival identifier preserves the correct arrival sequence, with the book/pages being used as a locater of the physical document, and to conform to historical practice and legal requirement.

After the book/pages number has been ascertained, a bar code label is created and attached to each page of the document. This bar code label contains the Arrival Identifier, i.e., the combined time stamp with document arrival sequence number, and book and page numbers in a machine and human readable format. The barcode also includes the page number of the document and the total number of pages in the document, e.g., page 1 of pages 16.

Upon scanning to create a digital image of the document, the system is able to identify each page and confirm that all pages have been scanned before allowing the receiving station to continue. The system allows receiving of documents via manual receiving stations as well as in conjunction with receiving electronic documents. Electronic documents that have been submitted to the system via an approved method are processed in the same sequential order as defined above.

Since each receiving station can function independently of the others, if desired, the station can acquire all needed information from the sets of documents and then return them to the individual that delivered them. All final processing steps that are required are performed via accessing the information entered in the system and the digital image of the documents. This feature saves time in having to move and sort the sets of physical documents, as well as having to then later return them to the appropriate individual. Further by labeling each document in a machine readable format and auto-verifying that all pages of the document have been correctly scanned and received, the risk of error due to physical pages being incorrectly sequenced, lost or accidentally mixed in with other documents, or other causes is greatly reduced.

Once all required data for performing searches on the documents is collected, the information is embedded in the digital images in an industry standard way that does not alter the appearance of the image. This data can be extracted and the indexing system used to search the documents electronically can be regenerated. This provides additional reliability if the related computerized search index is lost.

### DETAILED DESCRIPTION OF THE INVENTION

When a document source, e.g., a person, electronic transaction, mail package, etc., approaches a receiving station and requests for a document set to be recorded, the clerk at the receiving stations clicks a “To Begin Generate New Arrival Identifier” button in the system. This reserves the transaction's “Arrival Identifier”, comprised of a unique time stamp establishing the precise chronological order of when the person arrived, e.g., a time stamp with the year, month, day, hour, minute and second, and an appended document identifier number, e.g., a three digit number beginning with 000, to define the document ordering, with a different document identifier number being generated for each document in the document set. As will be later described, these numbers are printed on labels that are placed on each page of every document. The label also contains a page “(current page)” of “(total pages)” indicating what the current page is and how many pages are in the document, and the book/pages location.

As an example, a person submitted a document set comprised of a single one page document on Wednesday Morning, Jul. 5, 2006 at exactly 08:30 AM—the Arrival Identifier would be: 2006.07.05.08.30.00.000.

If the above person (or electronic transaction, mail package, etc.) had submitted a document set comprised of 3 documents the respective numbers for each document would be: First document: 2006.07.05.08.30.00.000; Second document: 2006.07.05.08.30.00.001; and Third document: 2006.07.05.08.30.00.002.

The “Arrival Identifiers” are created in the order they occur. In the event that multiple receiving stations click “To Begin Generate New Arrival Identifier” in close sequence together (e.g., all within the same second), each receiving station is granted an Arrival Identifier in the order that the request is received, with at least a predetermined time interval, e.g., a minimum of a one second gap, between issued Arrival Identifiers.

As an example, three people arrive in the Register of Deeds Office at the beginning of the day and walk up to the available receiving stations. Person (1) arrives first and has a set of 9 documents; person (2) arrives second and has a set of 1 document; and person (3) arrives third and has a set of 4 documents

Assuming it was the beginning of the day (exactly 08:30:01 AM) Jul. 3, 2006, Person (1) would receive the following Arrival Identifiers for each document: 2006.07.03.08.30.01.000; 2006.07.03.08.30.01.001; 2006.07.03.08.30.01.002; 2006.07.03.08.30.01.003; 2006.07.03.08.30.01.004; 2006.07.03.08.30.01.005; 2006.07.03.08.30.01.006; 2006.07.03.08.30.01.007; and 2006.07.03.08.30.01.008.

Person two (2), who also arrived at 08:30:01 AM on Jul. 3, 2006, but is behind Person one (1), would receive an Arrival Identifier for their single document of: 2006.07.03.08.30.02.000.

Person three (3), who is behind persons one (1) and two (2) would receive an Arrival Identifier for each document of: 2006.07.03.08.30.03.000; 2006.07.03.08.30.03.001; 2006.07.03.08.30.03.002; and 2006.07.03.08.30.03.003.

Note that with this sequencing method there is no need for any person to have to wait for another person's documents to be processed. And, all receiving stations can truly function in parallel. Also, since the document arrival order is established immediately upon document presentation (“Instant Service” style), the document processing can be completed at a later time (“Delayed Service” style) without any concern of loosing the proper ordering of document presentation.

Once the documents have been received and recorded with bar-coded labels printed, the arrival is closed. After that point, typically no additional documents can be received and recorded with that Arrival Identifier. The only exception to this being supervisory override in the case of a transaction error. This type of event would be logged in a transaction journal explaining what occurred. After the Arrival Identifier has been closed, clicking “To Begin Generate Arrival Identifier” starts the process again.

Once all processing has been completed on the document and the indexing data has been verified, this data is embedded into the digital image (in the industry standard fields already included in the digital image format) of the original scanned document. With the data embedded, the document can be accessed whenever needed using software that can read this data. This information includes all relevant indexing and search terms.

Normally the digital images are searched and found through a computerized index system. The limitation is that if this indexing search data is ever lost or corrupted, the digital images would have to be manually “re-indexed” and have their search related information re-added to the computerized search system. However, since the index and search related information is embedded in the digital images, assuming they are intact, the index data can be extracted and automatically rebuild the search data.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A method for assigning order arrival times to document sets received at multiple receiving locations while preserving the chronological arrival sequence of all documents sets at all receiving locations comprising:
a) receiving document sets at a plurality of said receiving locations; and
b) assigning a unique arrival identifier to each set, said identifier including a time stamp and a document number for each document in said set.

2. The method of claim 1, wherein said time stamp differs from the time stamp assigned to the immediately preceding set received at any other receiving station by a predetermined time segment.

3. The method of claim 2, wherein the predetermined time segment is at least one second.

4. The method of claim 1, wherein a barcode label including the unique arrival identifier is attached to each document in the document set.

6. The method of claim 1, wherein the time stamp includes the date, hour, minute and second that the unique identifier is assigned.

7. The method of claim 1, further including the step of scanning each document set to form one or more digitized images and embedding the unique identifier into the digitized images.

8. The method of claim 1, further including the step of determining a book and pages identifier for each document from a database.

9. The method of claim 1, wherein said documents are printed documents.

10. The method of claim 1, wherein said documents are electronic documents.

11. A method for assigning order arrival times to real estate deed sets received at multiple receiving locations while preserving the chronological arrival sequence of all real estate deed sets at all receiving locations comprising:
a) receiving real estate deed sets at a plurality of said receiving locations, each deed set including at least one document; and
b) assigning a unique arrival identifier to each document in each set, said identifier including a time stamp that is the same for all documents in each set and a document number that is unique for each document in said set, said time stamp differing from the time stamp assigned to the immediately preceding set received at any other receiving station by a predetermined time segment.

12. The method of claim 11, wherein a barcode label including the unique arrival identifier is attached to each document in the document set.

13. The method of claim 11, wherein the time stamp includes the date, hour, minute and second that the unique identifier is assigned.

14. The method of claim 11, wherein the predetermined time segment is at least one second.

15. The method of claim 11, further including the step of scanning each document set to form one or more digitized images and embedding the unique identifier into the digitized images.

16. The method of claim 11, wherein each document set is further assigned an indexing number comprised of a book number and one or more page numbers derived from a separate database of documents previously assigned unique identifiers.

17. The method of claim 16, wherein said indexing number is printed on a barcode label including the unique arrival identifier, said barcode label being attached to said document.

18. A method for recording real estate deed sets at multiple recording stations with each deed set being recorded in the order that the deed set is presented comprising:
a) providing a central database and a plurality of recording stations in communication with said central database;
b) receiving real estate deed sets at each of said recording stations independent of other recording stations, each deed set including at least one document;
c) assigning a unique arrival identifier to each set, said identifier including a time stamp that is the same for all documents in each set and a document number that is unique for each document in each set, said time stamp differing from the time stamp assigned to the immediately preceding set received at any other receiving station by a predetermined time segment.
d) assigning a book and page numbers to each document in said document set; and
e) attaching a barcode label including the unique arrival identifier and the book and page numbers to each document in the document set.

19. The method of claim 18, wherein said book and page number is acquired from a database of book and page numbers assigned to previously recorded documents.

20. The method of claim 18, further including the step of storing a hard copy of said document within a book corresponding to said book and page numbers.
